(19) United States
(12) Patent Application Publication
(10) Pub. No.: US 2024/0419855 A1
(43) Pub. Date: Dec. 19, 2024

(54) COMPLEX DEVICE KEY POSITION VIBRATION CHARACTERISTIC PARAMETER VERIFICATION METHOD

(71) Applicant: NANJING UNIVERSITY OF POSTS AND TELECOMMUNICATIONS, Jiangsu (CN)

(72) Inventors: Haigen YANG, Jiangsu (CN); Xiaolin ZHANG, Jiangsu (CN); Xu BAI, Jiangsu (CN); Zhe TONG, Jiangsu (CN)

(73) Assignee: NANJING UNIVERSITY OF POSTS AND TELECOMMUNICATIONS, Jiangsu (CN)

(21) Appl. No.: 18/817,151

(22) Filed: Aug. 27, 2024

Related U.S. Application Data
(63) Continuation of application No. PCT/CN2023/124021, filed on Oct. 11, 2023.

(30) Foreign Application Priority Data
Oct. 11, 2022 (CN) 202211237893.2

(51) Int. Cl. G06F 30/17; G06F 30/27

(52) U.S. Cl. CPC G06F 30/17; G06F 30/27

(57) ABSTRACT

Disclosed is a complex device key position vibration characteristic parameter verification method, comprising following steps: 1) constructing a model of complex device parts; 2) establishing a complex device dynamic model in a simulation software; 3) in the advancing process of a physical complex device, obtaining connection modes and constraint relationships among parts; 4) pre-simulating a complex device model in a dynamic simulation software; 5) determining a vibration characteristic parameter of a complex device key position needing to be verified, and carrying out post-processing on the vibration characteristic parameter for different levels of pavement spectra and vehicle speeds; 6) using a neural network model, training a selected key position rigidity damping coefficient and the vibration characteristic parameter; 7) comparing and verifying the vibration characteristic parameter obtained in the simulation process of the complex device dynamic model with the vibration characteristic parameter obtained by the neural network training model.

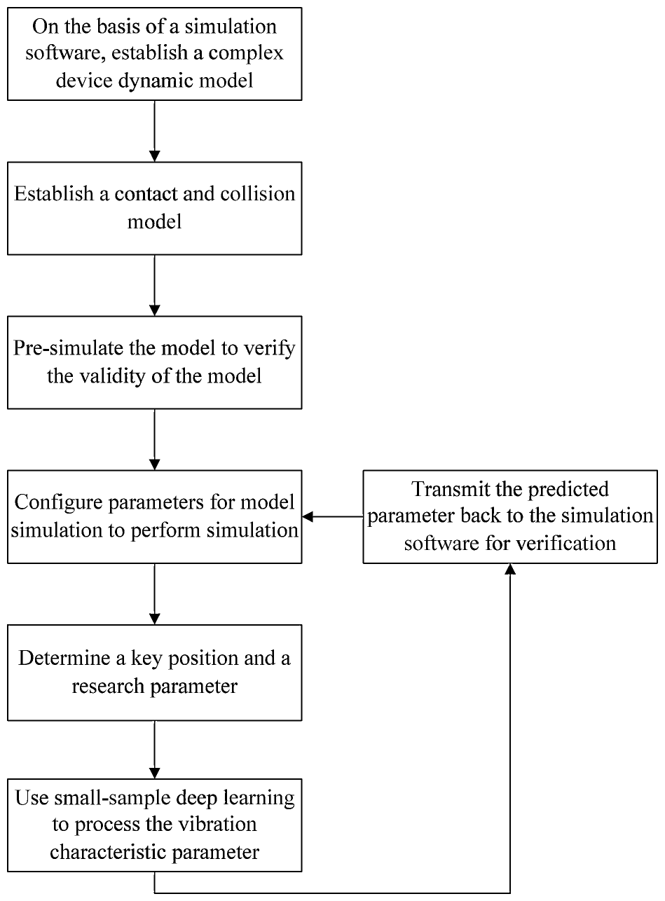

### CROSS-REFERENCE TO RELATED APPLICATION

This application is a continuation of international application of PCT application Ser. No. PCT/CN2023/124021 filed on Oct. 11, 2023, which claims the priority benefit of China application no. 202211237893.2 filed on Oct. 11, 2022. The entirety of each of the above mentioned patent applications is hereby incorporated by reference herein and made a part of this specification.

### TECHNICAL FIELD

The present invention relates to the technical field of equipment simulation, and particularly relates to a complex device key position vibration characteristic parameter analysis and verification method.

### BACKGROUND

With the rapid development of scientific information technology, manufacturing methods for complex device are becoming increasingly sophisticated, and there are more and more ways to combine the parts of equipment. Therefore, there is an urgent need for an efficient design method to analyze the vibration characteristics of key positions of a complex device. Traditional design methods are mainly based on practical experiments, and explore the optimization design solutions through continuous debugging, which is labor-intensive and resource-demanding. With the advent of virtual prototype technology, the development model for the complex device has shifted. Establishing a virtual prototype model, analyzing and studying key positions of the complex device and completing parameter optimization design during manufacturing have become an indispensable technical means in the device development process. Therefore, it is extremely important to study the influence of certain important parameters on vibration characteristics of key positions and to realize the analysis and verification of vibration characteristic parameters.

### SUMMARY

The present invention aims to solve the technical problem that vibration characteristics at key positions in the advancing process of a complex device are such as a suspension device and a torsion angle of balance shaft are hard to be detected. In the process of improving the vibration reduction of a complex device, how to verify the vibration characteristics at key positions of the complex device is a key problem.

In order to solve the above technical problems, the present invention adopts the following technical solution:
a complex device key position vibration characteristic parameter verification method, including following steps:
1) constructing a simulation model of complex device parts according to a principle of multi-body system dynamics, and carrying out sign convention for dynamic analysis;
2) establishing a complex device dynamic model in a dynamic simulation software, determining constraint relationships and forces of various parts of a complex device under a dynamic response of different levels of pavement spectra, finding corresponding constraint relationships and forces in a “Professional” bar in the dynamic simulation software, and adding the constraint relationships and forces to various parts of the simulation model;
3) obtaining connection modes and constraint relationships among the parts in the advancing process of a physical complex device, where the connection modes are used to assemble a virtual prototype model, and the constraint relationships are used to enable the virtual prototype model to be correctly simulated;
when the complex device is a tracked vehicle, the constraint relationships among the parts include:
revolute pairs among a vehicle body and the driving wheel, the loading wheel, and the track roller;
contact relationship between a ground and a track plate;
an initial angle of the balance shaft; and
a prismatic pair on a tensioning device;
4) pre-simulating the complex device dynamic model by giving simulation time and a step length in the dynamic simulation software, verifying the validity of the complex device dynamic model in a post-processing module by viewing an outputted chart, setting simulation parameters after validity verification is passed, and performing simulation of the complex device dynamic model; and the simulation parameters include the simulation time, the step length, a number of frames and the like;
5) determining a vibration characteristic parameter of a complex device key position needing to be verified, and carrying out post-processing on the vibration characteristic parameter for the different levels of pavement spectra and vehicle speeds;
6) using a neural network model, and training a selected key position rigidity damping coefficient and the vibration characteristic parameter to obtain a fitting relationship between the key position rigidity damping coefficient and the vibration characteristic parameter; and
7) transmitting a stiffness and damping coefficient of a suspension device obtained through a neural network training model to the dynamic simulation software, recalculating to obtain a vibration characteristic parameter in the post-processing module, comparing and verifying the vibration characteristic parameter obtained in the simulation process of the complex device dynamic model with the vibration characteristic parameter obtained by the neural network training model.

Beneficial effects: through a 3D modeling software, the present invention imports the part of the complex device into the dynamic simulation software, simulates the vibration model of key positions of the complex device to obtain the vibration characteristic parameters of key positions, analyzes and predicts the obtained parameters in combination with small sample deep learning, transmits the data obtained from the training of the neural network model back to the dynamic simulation software for comparison and verification, and analyzes the optimal situation of the vibration characteristics of key positions of the complex device while ensuring that the quality and moment of inertia of each part comply with the actual situation. Compared with the traditional design and manufacturing process of the complex device, the present invention can greatly reduce consumption of manpower and material resources.

### BRIEF DESCRIPTION OF THE DRAWINGS

FIG. is a flow chart of a complex device key position vibration characteristic parameter analysis and verification method according to an embodiment of the present invention.

### DESCRIPTION OF THE EMBODIMENTS

The present invention will be further described below with reference to the accompanying drawings. The following embodiments are merely used to more clearly describe the technical solutions of the present invention, instead of limiting the scope of protection of the present invention.

As shown in FIGURE, a complex device key position vibration characteristic parameter verification method includes following steps:
1) constructing a simulation model of complex device parts according to a principle of multi-body system dynamics, and carrying out sign convention for dynamic analysis;
2) establishing a complex device dynamic model in a dynamic simulation software, determining constraint relationships and forces of various parts of a complex device under a dynamic response of different levels of pavement spectra, finding corresponding constraint relationships and forces in a “Professional” bar in the dynamic simulation software, and adding the constraint relationships and forces to various parts of the simulation model;
3) obtaining connection modes and constraint relationships among the parts in the advancing process of a physical complex device, where the connection modes are used to assemble a virtual prototype model, and the constraint relationships are used to enable the virtual prototype model to be correctly simulated;
when the complex device is a tracked vehicle, the constraint relationships among the parts include:
revolute pairs among a vehicle body and a driving wheel, a loading wheel, and a track roller;
contact relationship between a ground and a track plate;
an initial angle of a balance shaft; and
a prismatic pair on a tensioning device;
4) pre-simulating the complex device dynamic model by giving simulation time and a step length in the dynamic simulation software, verifying the validity of the complex device dynamic model in a post-processing module by viewing an outputted chart, setting simulation parameters after validity verification is passed, and performing simulation of the complex device dynamic model; and the simulation parameters include the simulation time, the step length, a number of frames and the like;
5) determining a vibration characteristic parameter of a complex device key position needing to be verified, and carrying out post-processing on the vibration characteristic parameter for the different levels of pavement spectra and vehicle speeds;
6) using a neural network model, and training a selected key position rigidity damping coefficient and the vibration characteristic parameter to obtain a fitting relationship between the key position rigidity damping coefficient and the vibration characteristic parameter; and
7) transmitting a stiffness and damping coefficient of a suspension device obtained through a neural network training model to the dynamic simulation software, recalculating to obtain a vibration characteristic parameter in the post-processing module, comparing and verifying the vibration characteristic parameter obtained in the simulation process of the complex device dynamic model with the vibration characteristic parameter obtained by the neural network training model.

Further, in the step 1), in the process of constructing a simulation model of complex device parts, a topological diagram of the parts is constructed to represent the connection modes among the parts, and the parts are assembled into a model identical to the physical complex device in the dynamic simulation software.

In the process of assembling the parts into a model identical to the physical complex device in the dynamic simulation software, the parts of the complex device constructed by a three-dimensional modeling software are imported into the dynamic simulation software, and a model is established according to geometric position relationships of the parts, including the revolute pair added on the driving wheel, the loading wheel and the track roller, the prismatic pair required by the suspension device, and a contact relationship between the balance shaft and the loading wheel, and the like.

The parts are subjected to sign convention according to a driving mode of complex device such as the physical tracked vehicle, as well as the connection modes, and contact and collision methods, among the parts, and sign convention is performed for the parts, specifically, a part with mass is defined as a body element and denoted by a circle, a part without mass is a defined as a hinge element and denoted by a triangle, and the connection mode between the elements is denoted by an arrow.

Further, in the step 4), in the process of pre-simulating a complex device dynamic model, a driving force is applied to the complex device dynamic model imposed with constraint conditions; when the complex device is the tracked vehicle, a motion attribute is added to the revolute pair on the driving wheel of the tracked vehicle, a step function is added as the driving force to replace an engine module of a real complex device, “end time”, “step length” and “number of frames” are selected for pre-simulation, outputted results of a mass center of each part of the virtual prototype model is checked by clicking “Plot” in the post-processing module, and the outputted results include components in x, y, z coordinate directions of a mass center speed, an acceleration, a displacement, a torque and the like between the vehicle body and the balance shaft.

Further, in the step 5), when the complex device is the tracked vehicle, a target vibration characteristic parameter is root-mean-square values of the mass center vertical accelerations of the vehicle body and the balance shaft and a torsion angle of the balance shaft, and an analysis target is an influence of driving parameters of the driving wheel and the stiffness and damping coefficient of the suspension device on the target vibration characteristic parameter.

Further, in the step 5), the vibration characteristic parameter is obtained from the post-processing module of simulation results of the complex device dynamic model, the components of mass center vertical accelerations and the displacements of the vehicle body and the balance shaft in the y coordinate direction are outputted to a mathematical tool for post-processing, and the calculation is performed by using a following formula:

SQRT(SUMSQ(A:B)/N)

in the formula, A represents a starting point of data, B represents an ending point of the data, N represents a number of the data, and a root-mean-square value of the mass center vertical acceleration can be obtained by using the above formula, where SQRT represents a square root of returned values, and SUMSQ represents a sum of squares of the returned values.

Further, in the step 6), an analysis process specifically includes following steps: exporting output data and input data in a text form in the post-processing module of the dynamic simulation software, and performing data filling on the exported data through a generative adversarial network; and sending the data filled in the generative adversarial network to a fully connected neural network;
a generator and a discriminator of the generative adversarial network are each composed of a multi-layer residual neural network, an activation function in the residual neural network is a ReLu function, and an activation function of the fully connected neural network is the ReLU function or a Sigmoid function;
defining an input layer, a hidden layer and an output layer of the fully connected neural network, where the input layer is a speed, the stiffness and damping coefficient, and a pavement label of the suspension device of the complex device dynamic model;
the hidden layer is a mapping of the input layer under the action of the activation function;
the output layer is the selected vibration characteristic parameter, such as the mass center vertical acceleration of the vehicle body, the root-mean-square value of the mass center vertical acceleration of the balance shaft and the torsion angle of the balance shaft;
inputting data of the input layer into the Sigmoid activation function in the hidden layer, with a formula as follows:

$$f [ g ( {x}_{i} ) ] = \frac{1}{1 + {e}^{- g ( {x}_{i} )}}$$

converting g (x)=w*xᵢ+b inputted according to a linear combination relationship into a nonlinear relationship, where x; represents the stiffness and damping coefficient of the suspension device, which can be set according to actual situation through properties of the parts of the simulation software, w represents a weight, b represents a bias, e is an exponential function, g (xᵢ) is data of the input layer, and f [g(xᵢ)] means that the data of the input layer are transmitted to a Sigmoid function expression; and outputted results are the mass center vertical acceleration of the vehicle body, the root-mean-square value of the mass center vertical acceleration of the balance shaft, and the torsion angle of the balance shaft, and an optimal weight and a bias are fitted through the fully connected neural network.

Further, in the step 7), transmitting a stiffness and damping coefficient of a suspension device obtained through a neural network training model to the dynamic simulation software for verification, “end time”, “step length”, “number of frames” and the selected complex device key position vibration characteristic parameter are defined in the dynamic simulation software, simulation is then performed, the components of mass center vertical accelerations and the displacements of the vehicle body and the balance shaft in the y coordinate direction are outputted through the post-processing module of the dynamic simulation software to the mathematical tool for post-processing, a root-mean-square value of the mass center vertical acceleration is then obtained, and the root-mean-square value of the mass center vertical acceleration obtained in the simulation process is compared with a predicted center mass root-mean-square value obtained by the neural network training model for verification.

By setting the value of the stiffness and damping coefficient, the present invention trains the parameters through the neural network training model to obtain an optimal fitting curve, and accordingly obtains the mass center vertical acceleration of the vehicle body, the root-mean-square value of the mass center vertical acceleration of the balance shaft and the torsion angle of the balance shaft; the value of the stiffness and damping coefficient is then substituted into the dynamic simulation software, the stiffness and damping coefficient of the suspension device is set through properties for simulation, and the outputted root-mean-square value of the mass center vertical acceleration of the balance shaft and the torsion angle of the balance shaft are observed in the post-processing module of the dynamic simulation software, and are compared with the values obtained through the neural network training model for verification.

The above embodiments are merely intended for description of, rather than limitation to, the technical solutions of the present invention. Those of ordinarily skilled in the art should understand that they may still make modifications or equivalent replacements to the specific embodiments present invention without departing from the spirit and scope of the technical solutions of the present invention, all of which should be encompassed within the protection scope of the claims of the present invention.

What is claimed is:

1. A complex device key position vibration characteristic parameter verification method, comprising following steps:
1) constructing a simulation model of complex device parts according to a principle of multi-body system dynamics, and carrying out sign convention for dynamic analysis;
2) establishing a complex device dynamic model in a dynamic simulation software, determining constraint relationships and forces of various parts of a complex device under a dynamic response of different levels of pavement spectra, finding corresponding constraint relationships and forces in a “Professional” bar in the dynamic simulation software, and adding the constraint relationships and forces to various parts of the simulation model;
3) obtaining connection modes and constraint relationships among the parts in an advancing process of a physical complex device, wherein the connection modes are used to assemble a virtual prototype model, and the constraint relationships are used to enable the virtual prototype model to be correctly simulated;
4) pre-simulating the complex device dynamic model by giving a simulation time and a step length in the dynamic simulation software, verifying a validity of the complex device dynamic model in a post-processing module by viewing an outputted chart, setting simulation parameters after validity verification is passed, and performing simulation of the complex device dynamic model; and the simulation parameters comprise the simulation time, the step length and a number of frames;
5) determining a vibration characteristic parameter of a complex device key position needing to be verified, and carrying out post-processing on the vibration characteristic parameter for the different levels of pavement spectra and vehicle speeds;
6) using a neural network model, and training a selected key position rigidity damping coefficient and the vibration characteristic parameter to obtain a fitting relationship between the key position rigidity damping coefficient and the vibration characteristic parameter; and
7) transmitting a stiffness and damping coefficient of a suspension device obtained through a neural network training model to the dynamic simulation software, recalculating to obtain a vibration characteristic parameter in the post-processing module, comparing and verifying the vibration characteristic parameter obtained in the simulation process of the complex device dynamic model with the vibration characteristic parameter obtained by the neural network training model.

2. The complex device key position vibration characteristic parameter verification method according to claim 1, wherein in the step 1), in the process of constructing the simulation model of the complex device parts, a topological diagram of the parts is constructed to represent the connection modes among the parts, and the parts are assembled into a model identical to the physical complex device in the dynamic simulation software.

3. The complex device key position vibration characteristic parameter verification method according to claim 2, wherein in the process of assembling the parts into a model identical to the physical complex device in the dynamic simulation software, the parts of the complex device constructed by a three-dimensional modeling software are imported into the dynamic simulation software, and the model is established according to geometric position relationships of the parts, comprising revolute pairs added on a driving wheel, a loading wheel and a track roller, a prismatic pair required by the suspension device, and a contact relationship between a balance shaft and the loading wheel.

4. The complex device key position vibration characteristic parameter verification method according to claim 1, wherein in the step 3), when the complex device is a tracked vehicle, the constraint relationships among the parts comprise:
revolute pairs among a vehicle body and a driving wheel, a loading wheel, and a track roller;
contact relationship between a ground and a track plate;
an initial angle of a balance shaft; and
a prismatic pair on a tensioning device.

5. The complex device key position vibration characteristic parameter verification method according to claim 1, wherein in the step 4), in the process of pre-simulating the complex device dynamic model, a driving force is applied to the complex device dynamic model imposed with constraint conditions; when the complex device is a tracked vehicle, a motion attribute is added to the revolute pair on the driving wheel of the tracked vehicle, a step function is added as the driving force to replace an engine module of the physical complex device, “end time”, “step length” and “number of frames” are selected for pre-simulation, outputted results of a mass center of each part of the virtual prototype model is checked by clicking “Plot” in the post-processing module, and the outputted results comprise components in x, y, z coordinate directions of mass center speeds, accelerations, displacements, and torques a vehicle body and a balance shaft.

6. The complex device key position vibration characteristic parameter verification method according to claim 1, wherein in the step 5), when the complex device is a tracked vehicle, a target vibration characteristic parameter is root-mean-square values of mass center vertical accelerations of a vehicle body and a balance shaft and a torsion angle of the balance shaft, and an analysis target is an influence of driving parameters of a driving wheel and the stiffness and damping coefficient of the suspension device on the target vibration characteristic parameter.

7. The complex device key position vibration characteristic parameter verification method according to claim 6, wherein in the step 5), the vibration characteristic parameter is obtained from the post-processing module of simulation results of the complex device dynamic model, the components of mass center vertical accelerations and the displacements of the vehicle body and the balance shaft in a y coordinate direction are outputted to a mathematical tool for post-processing, and a calculation is performed by using a following formula:
SQRT(SUMSQ(A:B)/N)
in the formula, A represents a starting point of data, B represents an ending point of the data, N represents a number of the data, and the root-mean-square values of the mass center vertical acceleration can be obtained by using the above formula, wherein SQRT represents a square root of returned values, and SUMSQ represents a sum of squares of the returned values.

8. The complex device key position vibration characteristic parameter verification method according to claim 1, wherein in the step 6), an analysis process specifically comprises following steps:
exporting output data and input data in a text form in the post-processing module of the dynamic simulation software, and performing data filling on the exported data through a generative adversarial network; and sending the data filled in the generative adversarial network to a fully connected neural network;
a generator and a discriminator of the generative adversarial network are each composed of a multi-layer residual neural network, an activation function in the residual neural network is a ReLU function, and an activation function of the fully connected neural network is the ReLU function or a Sigmoid function; and
defining an input layer, a hidden layer and an output layer of the fully connected neural network, wherein the input layer is a speed, the stiffness and damping coefficient, a pavement label of the suspension device of the complex device dynamic model; the output layer is the selected vibration characteristic parameter, such as the mass center vertical acceleration of a vehicle body, a root-mean-square value of the mass center vertical acceleration of a balance shaft and a torsion angle of the balance shaft.

9. The complex device key position vibration characteristic parameter verification method according to claim 8, wherein inputting data of the input layer into the Sigmoid activation function in the hidden layer, with a formula as follows:
$$f [ g ( {x}_{i} ) ] = \frac{1}{1 + {e}^{- g ( {x}_{i} )}}$$
converting g(x)=w*xᵢ+b inputted according to a linear combination relationship into a nonlinear relationship, wherein x; represents the stiffness and damping coefficient of the suspension device, which can be set according to actual situation through properties of the parts of the simulation software, w represents a weight, b represents a bias, e is an exponential function, g (xᵢ) is data of the input layer, and f[g(xᵢ)] means that the data of the input layer are transmitted to a Sigmoid function expression; and outputted results are the mass center vertical acceleration of the vehicle body, the root-mean-square value of the mass center vertical acceleration of the balance shaft, and the torsion angle of the balance shaft, and an optimal weight and a bias are fitted through the fully connected neural network.

10. The complex device key position vibration characteristic parameter verification method according to claim 1, wherein in the step 7), transmitting the stiffness and damping coefficient of the suspension device obtained through the neural network training model to the dynamic simulation software for verification, “end time”, “step length”, “number of frames” and the selected complex device key position vibration characteristic parameter are defined in the dynamic simulation software, simulation is then performed, the components of the mass center vertical accelerations and the displacements of a vehicle body and a balance shaft in a y coordinate direction are outputted through the post-processing module of the dynamic simulation software to a mathematical tool for post-processing, a root-mean-square value of the mass center vertical acceleration is then obtained, and the root-mean-square value of the mass center vertical acceleration obtained in the simulation process is compared with a predicted center mass root-mean-square value obtained by the neural network training model for verification.
